(19) United States
(12) Patent Application Publication
(10) Pub. No.: US 2008/0118830 A1
(43) Pub. Date: May 22, 2008

(54) MULTI-LAYERED POLYMER PACKAGE FOR FILM BATTERY AND COMBINED PACKAGE AND CURRENT COLLECTOR

(75) Inventors: Young-gi Lee, Daejeon-city (KR); Kwang Sun Ryu, Daejeon-city (KR); Kwang Man Kim, Daejeon-city (KR); Junho Yeo, Daejeon-city (KR); Cheol Sig Pyo, Daejeon-city (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-City (KR)

(21) Appl. No.: 11/861,350

(22) Filed: Sep. 26, 2007

(30) Foreign Application Priority Data
Nov. 16, 2006 (KR) 10-2006-0113482
Mar. 20, 2007 (KR) 10-2007-0027291

(51) Int. Cl. H01M 2/02

(52) U.S. Cl. 429/176; 429/163

(57) ABSTRACT

Provided are a multi-layered polymer package for a film battery and a combined package and current collector. The polymer package for the film battery and the combined package and current collector include a multi-layered polymer film having a construction of at least three layers, which includes a first polymer film, a second polymer film, and a third polymer film, the first, second, and third polymer films being made of different materials. The first polymer film is made of a hydrocarbon compound which is unsubstituted or substituted by a fluorine (F) atom. The second polymer film is made of an amorphous polymer. The third polymer film is made of a polymer having a tensile strength of a predetermined value or more and a tensile modulus of a predetermined value or more. In the combined package and current collector, a conductive layer is disposed on a surface of the multi-layered polymer film.

### CROSS-REFERENCE TO RELATED PATENT APPLICATION

This application claims benefits from Korean Patent Application No. 10-2006-0113482, filed on Nov. 16, 2006, and No. 10-2007-0027291, filed on Mar. 20, 2007, in the Korean Intellectual Property Office, the disclosures of which are incorporated herein in their entirety by reference.

### BACKGROUND OF THE INVENTION

1. Field of the Invention

The present invention relates to a package and a current collector for a film battery, and more particularly, to a polymer package for a film battery, including a multi-layered polymer film, and a combined package and current collector.

2. Description of the Related Art

Recently, active radio frequency identification (RFID) and sensor node technologies have been actively studied. These technologies, together with digital TVs, home networks, and intelligent robots, are expected to become future important technologies which are superior to the currently available code division multiple access (CDMA) technology. That is, the active RFID and sensor node technologies deviate from a passive function of reading information included in a tag through a reader, and can remarkably increase the recognition distance of tags. Moreover, by sensing information about an object located around a tag and environmental information, the active RFID and sensor node technologies are expected to expand a scope of information flow beyond communication between people and objects to communication between objects by means of networking. Thus, in order to operate such RFID tags and sensor nodes, it is important to secure a power source completely independent from a reader by using a subminiature, lightweight, and long-lasting power device which is suitable for standardized tags or nodes.

To date, attempts have been made to partially apply many power devices to RFID tags and sensor nodes, and the possibility of the application of some power devices in RFID tags and sensor nodes has been acknowledged. Film primary batteries are an example of such a power device. The constructions of electrodes and electrolytes of film primary batteries are the same as those of conventional dry cells and alkaline batteries. However, film primary batteries are not contained in conventional cylindrical cans but are packed with polyethylene terephthalate (PET)-based laminated films. Conventional PET-based films used for packing film primary batteries show good blocking characteristics due to low oxygen permeability. However, PET-based packages have relatively high hydrophilicity due to the presence of surface ester groups, compared to polyolefin-based packages. Thus, the PET-based packages may show increased moisture and oxygen permeability when excess moisture is present in the surroundings. Moreover, in some cases, moisture contained in an electrolyte solution inside a package easily penetrates a film(s) constituting the package, and thus, evaporation and leakage of the moisture through the package may occur. In addition, PET-based films have a poor corrosion resistance against strong acids or bases, and thus, a direct contact of the films with a strongly acidic or basic electrolyte solution may cause the corrosion of the films. These disadvantages adversely affect the durability, long-term storage stability, and lifetime characteristics of film batteries.

### SUMMARY OF THE INVENTION

The present invention provides a polymer package for a film battery, which can efficiently discharge gases with a small molecular size (e.g., hydrogen gas) commonly generated in a battery, can prevent the evaporation or leakage of moisture contained in an electrolyte solution, can prevent permeation of external moisture and oxygen, and has a good corrosion resistance against a strongly acidic or basic aqueous electrolyte solution.

The present invention also provides a combined package and current collector in which a current collector is integrally combined with a package having the above-described characteristics, and which can be advantageously applied in a film battery.

According to an aspect of the present invention, there is provided a polymer package for a film battery, the polymer package including a multi-layered polymer film having a construction of at least three layers, which includes a first polymer film, a second polymer film, and a third polymer film, the first, second, and third polymer films being made of different materials. The first polymer film is made of a hydrocarbon compound which is unsubstituted or substituted by a fluorine (F) atom. The second polymer film is made of an amorphous polymer. The third polymer film is made of a polymer having a tensile strength of at least 100 MPa (MD) and a tensile modulus of at least 3000 MPa (MD).

A surface of the first polymer film may constitute a first surface of the multi-layered polymer film.

The multi-layered polymer film may further include a fourth polymer film. A surface of the fourth polymer film may constitute a second surface of the multi-layered polymer film opposite to the first surface.

A polymer adhesive layer may be interposed between the first polymer film and the second polymer film and between the second polymer film and the third polymer film.

At least one polymer film selected from the second polymer film and the third polymer film of the multi-layered polymer film may be formed having a plurality of films.

According to another aspect of the present invention, there is provided a combined film battery package and current collector including: a multi-layered polymer film having a construction of at least three layers, which includes a first polymer film, a second polymer film, and a third polymer film, the first, second, and third polymer films being made of different materials; and a conductive layer disposed on a surface of the multi-layered polymer film.

The conductive layer may include a nonmetallic conducting agent and a binder.

In the combined film battery package and current collector, a surface of the first polymer film may constitute a first surface of the multi-layered polymer film and the conductive layer may be disposed on a second surface of the multi-layered polymer film opposite to the first surface.

In the combined film battery package and current collector, the multi-layered polymer film may further include a fourth polymer film interposed between the third polymer film and the conductive layer.

When a polymer package for a film battery and a combined package and current collector according to the present invention are applied in manufacturing a film battery, a hydrogen gas generated in the film battery during discharging is gradually discharged from the battery and permeation of air into the film battery is prevented, thereby constantly maintaining the content of moisture in an electrolyte solution of the film battery. Moreover, the polymer package and the combined package and current collector according to the present invention exhibit a good corrosion resistance against strong acids and bases, and can prevent the permeation and penetration of an electrolyte solution through films, thereby enhancing the capacity utilization and energy density of the film battery, high-rate discharge characteristics, and pulse discharge characteristics. The polymer package for the film battery according to the present invention can be mass-produced at low costs.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view illustrating an essential part of a polymer package for a film battery according to a first embodiment of the present invention;

FIG. 2 is a sectional view illustrating an essential part of a polymer package for a film battery according to a second embodiment of the present invention; and

FIG. 3 is a sectional view illustrating an essential part of a combined film battery package and current collector according to an exemplary embodiment of the present invention.

### DETAILED DESCRIPTION OF THE INVENTION

The present invention will now be described more fully with reference to the accompanying drawings, in which exemplary embodiments of the invention are shown.

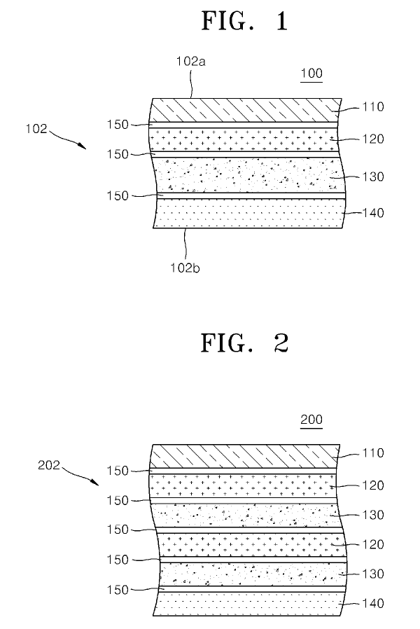

FIG. 1 is a sectional view illustrating an essential part of a polymer package 100 for a film battery according to a first embodiment of the present invention.

Referring to FIG. 1, the polymer package 100 for the film battery according to the first embodiment of the present invention includes a multi-layered polymer film 102 having a construction of at least three layers, which includes a first polymer film 110, a second polymer film 120, and a third polymer film 130, the first, second, and third polymer films 110, 120, and 130 being made of different materials.

FIG. 1 illustrates that the multi-layered polymer film 102 further includes a fourth polymer film 140, in addition to the first polymer film 110, the second polymer film 120, and the third polymer film 130.

The first polymer film 110 is made of a hydrocarbon compound which is unsubstituted or substituted by a fluorine (F) atom. For example, the first polymer film 110 may be made of a polymer or a blend of two or more polymers selected from the group consisting of polyethylene, polypropylene, polyvinylidenefluoride, polytetrafluoroethylene, and polystyrene.

The first polymer film 110 consists of either elements C and H or elements C, H, and F, and thus, is highly hydrophobic. Thus, when the multi-layered polymer film 102 is used as a package for a film battery, the first polymer film 110 constitutes an outermost layer of the multi-layered polymer film 102, thereby preventing permeation of external oxygen or moisture and the evaporation and leakage of moisture contained in an electrolyte solution of the film battery.

The second polymer film 120 is made of an amorphous polymer. For example, the second polymer film 120 may be made of a polymer or a blend of two or more polymers selected from the group consisting of polyvinylchloride, polyvinylidenechloride, nylon, polyacrylonitrile, and polyvinylalcohol.

The second polymer film 120 prevents permeation of external oxygen and carbon dioxide.

The third polymer film 130 is made of a polymer having a tensile strength of at least 100 MPa (MD) and a tensile modulus of at least 3000 MPa (MD). For example, the third polymer film 130 may be made of a polyester-based polymer, e.g., polyethyleneterephthalate or polybutyleneterephthalate. Polyethyleneterephthalate has a tensile strength of about 150 to 200 MPa (MD) and a tensile modulus of about 4000 to 5000 MPa (MD). Polybutyleneterephthalate has a tensile strength of about 100 to 200 MPa (MD) and a tensile modulus of about 4000 to 5000 MPa (MD).

The third polymer film 130 serves to enhance the mechanical strength of the multi-layered polymer film 102 and to prevent permeation of external oxygen.

When a film, e.g., a conductive film for a current collector, is attached to the multi-layered polymer film 120, the fourth polymer film 140 is used as a base film for coating the conductive film on the multi-layered polymer film 102. A polymer material used for forming the fourth polymer film 140 is not particularly limited and may be optionally selected from various polymers. For example, the fourth polymer film 140 may be made of a polymer or a blend of two or more polymers selected from the group consisting of polyethylene, polypropylene, polyvinylchloride, polyvinylidenechloride, polyvinylidenefluoride, a copolymer of vinylidenefluoride and hexafluoropropylene, a copolymer of vinylidenefluoride and trifluoroethylene, a copolymer of vinylidenefluoride and tetrafluoroethylene, nylon, polyacrylonitrile, polyvinylalcohol, and ethylvinylalcohol.

The fourth polymer film 140 imparts chemical resistance to the multi-layered polymer film 102. Thus, even when the multi-layered polymer film 102 is exposed to severe conditions (e.g., strong acid or base), damage to the multi-layered polymer film 102 can be prevented.

As illustrated in FIG. 1, the first polymer film 110, the second polymer film 120, the third polymer film 130, and the fourth polymer film 140 are adhered to each other via a polymer adhesive layer 150 interposed between each pair of the films.

For example, the polymer adhesive layer 150 may be made of a polymer or a blend of two or more polymers selected from the group consisting of polyethylene, polypropylene, polyurethane, and an acrylate-based polymer. Examples of the acrylate-based polymer suitable to be used in the present invention include polymethylacrylate, polyethylacrylate, polymethylmethacrylate, polyethylmethacrylate, polybutylacrylate, and polybutylmethacrylate.

The first polymer film 110 is formed as an outermost layer of the multi-layered polymer film 102 so that a surface of the first polymer film 110 constitutes an outermost surface, i.e., a first surface 102a, of the multi-layered polymer film 102. The fourth polymer film 140 is formed as the other outermost layer of the multi-layered polymer film 102 so that a surface of the fourth polymer film 140 constitutes the other outermost surface, i.e., a second surface 102b opposite to the first surface 102a, of the multi-layered polymer film 102.

In the polymer package 100 for the film battery, each of the first polymer film 110, the second polymer film 120, the third polymer film 130, and the fourth polymer film 140 may have a thickness of 1 to 100 μm, and the polymer adhesive layer 150 may have a thickness of about 0.1 to 50 μm. The polymer package 100 for the film battery may have a thickness of about 5 to 450 μm.

Hereinafter, a method of manufacturing the polymer package 100 for the film battery illustrated in FIG. 1 will be exemplarily described.

First, both surfaces of each of the first polymer film 110, the second polymer film 120, the third polymer film 130, and the fourth polymer film 140 are subjected to a corona discharge treatment. The corona discharge treatment facilitates an adhesion between the polymer adhesive layer 150 and each of the first polymer film 110, the second polymer film 120, the third polymer film 130, and the fourth polymer film 140, and a lamination of the first polymer film 110, the second polymer film 120, the third polymer film 130, and the fourth polymer film 140. Moreover, when a conductive layer is coated on a surface of the multi-layered polymer film 102 to form a current collector or an electrode using the multi-layered polymer film 102 as a base film, the surface of the multi-layered polymer film 102 is modified hydrophilic by the corona discharge treatment to efficiently perform the coating.

The first polymer film 110, the second polymer film 120, the third polymer film 130, and the fourth polymer film 140 may be each obtained by forming a molten resin extruded from an extruder into a film type. In particular, the second polymer film 120 made of an amorphous polymer may be formed as follows. For example, a molten polymer, which is in an amorphous phase and has a very slow crystallization rate, is drawn from an extruder and quenched to thereby form a polymer film having an amorphous oriented state.

Next, a polymer adhesive either flows or is attached between the first polymer film 110, the second polymer film 120, the third polymer film 130, and the fourth polymer film 140, which have been subjected to the corona discharge treatment, and the first polymer film 110, the second polymer film 120, the third polymer film 130, and the fourth polymer film 140 are then laminated. For example, the multi-layered polymer film 102 having an improvement in corrosion resistance and mechanical properties can be obtained in such a manner that a polymer adhesive layer 150 is formed on the fourth polymer film 140, the third polymer film 130 is laminated, another polymer adhesive layer 150 is formed on the third polymer film 130, the second polymer film 120 is laminated, another polymer adhesive layer 150 is formed on the second polymer film 120, and the first polymer film 110 is laminated.

FIG. 2 is a sectional view illustrating an essential part of a polymer package 200 for a film battery according to a second embodiment of the present invention. In FIG. 2, the same reference numerals as in FIG. 1 illustrating the first embodiment of the present invention refer to the same constitutional elements.

Referring to FIG. 2, the polymer package 200 for the film battery according to the second embodiment of the present invention is generally similar to the polymer package (see 100 in FIG. 1) for the film battery according to the first embodiment of the present invention except that the polymer package 200 includes a multi-layered polymer film 202 including a plurality of second polymer films 120 and third polymer films 130. FIG. 2 illustrates that the multi-layered polymer film 202 includes two second polymer films 120 and two third polymer films 130.

As illustrated in FIG. 2, by forming the plurality of the second polymer films 120 and the third polymer films 130, it is possible to further enhance the oxygen permeation prevention characteristics and mechanical strength of the polymer package 200.

In the polymer packages for film batteries according to the above embodiments described with reference to FIGS. 1 and 2, by adjusting the thicknesses and number of films constituting the polymer packages, it is possible to adjust the degree of film permeation of internal gases, which are generated in the batteries, and external gases, which should be blocked from an ambient environment, according to the molecular size of the internal gases and the type of the external gases, and to guarantee a desired mechanical strength. Moreover, the polymer packages have a good corrosion resistance, and thus, when used as packages for film batteries, can improve the long-term stability and lifetime characteristics of the batteries. In addition, the polymer packages can be embodied in the form of multi-layered polymer films having various characteristics according to the requirements of film batteries, and can be manufactured in a simple and easy manner.

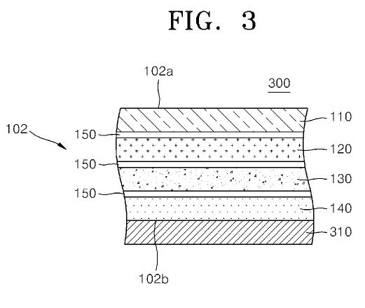

FIG. 3 is a sectional view illustrating an essential part of a combined film battery package and current collector 300 according to an exemplary embodiment of the present invention. In FIG. 3, the same reference numerals as in FIG. 1 illustrating the first embodiment of the present invention refer to the same constitutional elements.

Referring to FIG. 3, the combined film battery package and current collector 300 according to the current embodiment of the present invention includes a multi-layered polymer film 102 and a conductive layer 310 disposed on a surface of the multi-layered polymer film 102. FIG. 3 illustrates that the multi-layered polymer film 102 of the combined film battery package and current collector 300 is the same as the multi-layered polymer film of the polymer package illustrated in FIG. 1, but the present invention is not limited thereto. For example, the multi-layered polymer film 102 of the combined film battery package and current collector 300 may be the same as the multi-layered polymer film of the polymer package illustrated in FIG. 2, or alternatively, may be structured such that at least one film selected from first, second, and third polymer films 110, 120, and 130 is formed having a plurality of films.

The conductive layer 310 may have a thickness of about 1 to 100 μm. The conductive layer 310 includes a nonmetallic conducting agent and a binder.

The nonmetallic conducting agent contained in the conductive layer 310 may be a conductive carbon. For example, the nonmetallic conducting agent may be at least one material selected from the group consisting of graphite, carbon black, Denka Black, Lonza carbon, Super-P, activated carbon MSC30, and carbon nanotubes.

The binder contained in the conductive layer 310 may be a polymer or a blend of two or more polymers selected from the group consisting of polyethyleneoxide, polypropyleneoxide, starch, polyacrylic acid, polyvinylalcohol, polyvinylacetate, cellulose, cellulose acetate, carboxymethylcellulose, methylcellulose, ethylcellulose, butylcellulose, polyvinylchloride, polyvinylidenechloride, polyvinylidenefluoride, polytetrafluoroethylene, and Nafion.

In the combined film battery package and current collector 300, a surface of the first polymer film 110 constitutes a first surface 102a of the multi-layered polymer film 102, and the conductive layer 310 is formed on a second surface 102b of the multi-layered polymer film 102 opposite to the first surface 102a.

As illustrated in FIG. 3, in the combined film battery package and current collector 300, a polymer package is integrally combined with a current collector by forming the conductive layer 310 on a surface of the multi-layered polymer film 102. Thus, application of the combined film battery package and current collector 300 in manufacturing a film battery enables the realization of a nonmetallic current collector for the film battery, thereby decreasing the weight of the film battery and assuring good bending characteristics. In particular, since the fourth polymer film 140 imparts chemical resistance to the multi-layered polymer film 102, even when the combined film battery package and current collector 300 is exposed to a strongly acidic or basic electrolyte solution, the corrosion of the combined film battery package and current collector 300 can be prevented.

Hereinafter, polymer packages for film batteries according to the present invention will be described more specifically with reference to the following manufacturing examples. The following manufacturing examples are only for illustrative purposes and are not intended to limit the scope of the invention. It should be understood that various changes or modifications may be made in the manufacturing examples without departing from the spirit of the present invention.

### EXAMPLE 1

Polyethylene films having a thickness of 10 μm were prepared as first polymer films, extruded amorphous polypropylene films having a thickness of 25 μm were prepared as second polymer films, extruded polyethyleneterephthalate films having a thickness of 16 μm were prepared as third polymer films, and extruded white polypropylene films having a thickness of 25 μm were prepared as fourth polymer films. Then, both surfaces of each of the first, second, third, and fourth polymer films were subjected to a corona discharge treatment. The first, second, third, and fourth polymer films were sequentially laminated with adhesive layers interposed therebetween to obtain multi-layered polymer films. Polyethylene films having a thickness of 5 μm were used as the adhesive layers.

### EXAMPLE 2

Multi-layered polymer films were manufactured in the same manner as in Example 1 except that ethylenevinylalcohol films having a thickness of 25 μm were used as second polymer films.

### EXAMPLE 3

Multi-layered polymer films were manufactured in the same manner as in Example 1 except that nylon films having a thickness of 25 μm were used as second polymer films.

### EXAMPLE 4

Multi-layered polymer films were manufactured in the same manner as in Example 1 except that polyvinylidenechloride films having a thickness of 25 μm were used as second polymer films.

### EXAMPLE 5

Multi-layered polymer films were manufactured in the same manner as in Example 1 except that polyacrylonitrile films having a thickness of 25 μm were used as second polymer films.

### COMPARATIVE EXAMPLE

In order to evaluate the permeation characteristics and corrosion resistance of the multi-layered polymer films manufactured in Examples 1-5, conventional polyethyleneterephthalate-based films used as packages for film batteries were manufactured. That is, both surfaces of each of two polyethyleneterephthalate films having a thickness of 40 μm were subjected to a corona discharge treatment, and the polyethyleneterephthalate films were adhered to each other using adhesive layers to obtain dual-layered polyethyleneterephthalate polymer films having a thickness of 86 μm.

Degrees of permeation of oxygen, carbon dioxide, and moisture into the multi-layered polymer films manufactured in Examples 1-5 and Comparative Example are measured and the results are presented in Table 1 below. The degrees of permeation were measured at room temperature under atmospheric pressure.

TABLE 1

| | | Comparative | | | | | |
|---|---|---|---|---|---|---|---|
| Polymer films | | Example | Example 1 | Example 2 | Example 3 | Example 4 | Example 5 |
| Degree of permeation, | O₂ | 0.0257 | 0.0285 | 0.0011 | 0.0099 | 0.0013 | 0.0014 |
| P(×10¹³)[(cm² · cm)/[cm² · s · Pa]) | CO₂ | 0.118 | 0.066 | 0.00924 | 0.0218 | 0.0110 | 0.0135 |
| @STP | H₂O | 113 | 23 | 41 | 59 | 12 | 7 |

As shown in Table 1, the multi-layered polymer films manufactured in Examples 1-5 exhibited better prevention characteristics of oxygen, carbon dioxide, and moisture permeation than the multi-layered polymer films manufactured in Comparative Example. These results show that when a multi-layered polymer film according to the present invention is used as a package for a film battery or a combined film battery package and current collector, it is possible to effectively prevent the permeation of external air and moisture into the battery.

Meanwhile, corrosion resistance of the multi-layered polymer films manufactured in Examples 1-5 and Comparative Example in an electrolyte solution including a 6 M NH₄Cl solution and an electrolyte solution including a 6 M KOH solution was evaluated, and the results are presented in Table 2 below.

TABLE 2

| | | Comparative | | | | | |
|---|---|---|---|---|---|---|---|
| Polymer films | | Example | Example 1 | Example 2 | Example 3 | Example 4 | Example 5 |
| Electrolyte | 6M KOH | ◯ | X | X | X | X | X |
| solution | solution | | | | | | |
| | 6M NH₄Cl | Δ | X | X | X | X | X |
| | solution | | | | | | |

“◯”: severe corrosion on surface of film
“Δ”: slight corrosion on surface of film
“X”: no corrosion

As shown in Table 2, the multi-layered polymer films manufactured in Example 1-5 according to the present invention exhibited a good corrosion resistance to strong acid and base conditions. These results show that a multi-layered polymer film according to the present invention has a good corrosion resistance when applied to a conventional manganese battery or alkaline battery, thereby preventing battery degradation.

A polymer package for a film battery according to the present invention includes first, second, and third polymer films that are made of different materials. In particular, the first polymer film is made of a hydrocarbon compound which is unsubstituted or substituted by a F atom so that an outermost surface of the package is hydrophobic, the second polymer film is made of an amorphous polymer capable of preventing permeation of external oxygen and carbon dioxide, and the third polymer film is made of a polymer having a tensile strength of a predetermined value or more and a tensile modulus of a predetermined value or more so that the package has a good mechanical strength. Thus, the polymer package for the film battery according to the present invention allows the permeation of gases with a small molecular size (e.g., hydrogen gas) but can prevent permeation of oxygen and carbon dioxide in air and moisture.

When a polymer package for a film battery or a combined package and current collector according to the present invention is applied in manufacturing a film battery, a hydrogen gas generated in the film battery during discharging is gradually discharged from the film battery and permeation of air into the film battery is prevented, thereby constantly maintaining the content of moisture in an electrolyte solution of the film battery. Therefore, long-term stability of the film battery can be enhanced, and even when discharging is performed for a long time, the performance of the film battery can be stably maintained. Moreover, the polymer package for the film battery according to the present invention is not corroded even when exposed to a strong acid or base for a long time, and the permeation and penetration of an electrolyte solution through a film can be prevented, thereby preventing leakage of the electrolyte solution. Therefore, it is possible to enhance the capacity utilization and energy density of the film battery, high-rate discharge characteristics, and pulse discharge characteristics.

The polymer package for the film battery according to the present invention can be manufactured using a conventional method commonly applied to manufacture multi-layered films, thereby reducing production costs and enabling mass-production.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A polymer package for a film battery, the polymer package comprising a multi-layered polymer film having a construction of at least three layers, which comprises a first polymer film, a second polymer film, and a third polymer film, the first, second, and third polymer films being made of different materials,
wherein the first polymer film is made of a hydrocarbon compound which is unsubstituted or substituted by a fluorine (F) atom, the second polymer film is made of an amorphous polymer, and the third polymer film is made of a polymer having a tensile strength of at least 100 MPa (MD) and a tensile modulus of at least 3000 MPa (MD).

2. The polymer package of claim 1, wherein the first polymer film is made of a polymer or a blend of two or more polymers selected from the group consisting of polyethylene, polypropylene, polyvinylidenefluoride, polytetrafluoroethylene, and polystyrene.

3. The polymer package of claim 1, wherein the second polymer film is made of a polymer or a blend of two or more polymers selected from the group consisting of polyvinylchloride, polyvinylidenechloride, nylon, polyacrylonitrile, and polyvinylalcohol.

4. The polymer package of claim 1, wherein the third polymer film is made of a polyester-based polymer.

5. The polymer package of claim 4, wherein the third polymer film is made of polyethyleneterephthalate or polybutyleneterephthalate.

6. The polymer package of claim 1, wherein a surface of the first polymer film constitutes a first surface of the multi-layered polymer film.

7. The polymer package of claim 6, wherein the multi-layered polymer film further comprises a fourth polymer film, and a surface of the fourth polymer film constitutes a second surface of the multi-layered polymer film opposite to the first surface.

8. The polymer package of claim 1, wherein the fourth polymer film is made of a polymer or a blend of two or more polymers selected from the group consisting of polyethylene, polypropylene, polyvinylchloride, polyvinylidenechloride, polyvinylidenefluoride, a copolymer of vinylidenefluoride and hexafluoropropylene, a copolymer of vinylidenefluoride and trifluoroethylene, a copolymer of vinylidenefluoride and tetrafluoroethylene, nylon, polyacrylonitrile, polyvinylalcohol, and ethylvinylalcohol.

9. The polymer package of claim 1, wherein a polymer adhesive layer is interposed between the first polymer film and the second polymer film and between the second polymer film and the third polymer film.

10. The polymer package of claim 9, wherein the polymer adhesive layer is made of a polymer or a blend of two or more polymers selected from the group consisting of polyethylene, polypropylene, polyurethane, and an acrylate-based polymer.

11. The polymer package of claim 10, wherein the acrylate-based polymer is at least one selected from the group consisting of polymethylacrylate, polyethylacrylate, polymethylmethacrylate, polyethylmethacrylate, polybutylacrylate, and polybutylmethacrylate.

12. The polymer package of claim 1, wherein at least one polymer film selected from the second polymer film and the third polymer film of the multi-layered polymer film is formed having a plurality of films.

13. A combined film battery package and current collector comprising: a multi-layered polymer film having a construction of at least three layers, which comprises a first polymer film, a second polymer film, and a third polymer film, the first, second, and third polymer films being made of different materials; and a conductive layer disposed on a surface of the multi-layered polymer film, wherein in the multi-layered polymer film, the first polymer film is made of a hydrocarbon compound which is unsubstituted or substituted by a fluorine (F) atom, the second polymer film is made of an amorphous polymer, and the third polymer film is made of a polymer having a tensile strength of at least 100 MPa (MD) and a tensile modulus of at least 3000 MPa (MD).

14. The combined film battery package and current collector of claim 13, wherein the conductive layer comprises a nonmetallic conducting agent and a binder.

15. The combined film battery package and current collector of claim 14, wherein the nonmetallic conducting agent comprises a conductive carbon.

16. The combined film battery package and current collector of claim 15, wherein the conductive carbon is at least one material selected from the group consisting of graphite, carbon black, Denka Black, Lonza carbon, Super-P, activated carbon MSC30, and carbon nanotubes.

17. The combined film battery package and current collector of claim 14, wherein the binder is a polymer or a blend of two or more polymers selected from the group consisting of polyethyleneoxide, polypropyleneoxide, starch, polyacrylic acid, polyvinylalcohol, polyvinylacetate, cellulose, cellulose acetate, carboxymethylcellulose, methylcellulose, ethylcellulose, butylcellulose, polyvinylchloride, polyvinylidenechloride, polyvinylidenefluoride, polytetrafluoroethylene, and Nafion.

18. The combined film battery package and current collector of claim 13, wherein a surface of the first polymer film constitutes a first surface of the multi-layered polymer film and the conductive layer is disposed on a second surface of the multi-layered polymer film opposite to the first surface.

19. The combined film battery package and current collector of claim 18, wherein the multi-layered polymer film further comprises a fourth polymer film interposed between the third polymer film and the conductive layer.
